(19) United States
(12) Patent Application Publication
(10) Pub. No.: US 2020/0335015 A1
(43) Pub. Date: Oct. 22, 2020

(54) MERCHANDISE SHELF

(71) Applicant: TOSHIBA TEC KABUSHIKI KAISHA, Tokyo (JP)

(72) Inventors: Yumiko Okuma, Nakano Tokyo (JP); Sayo Sonaga, Yokohama Kanagawa (JP); Mayuko Tsunoda, Yokohama Kanagawa (JP); Masayuki Nakaeda, Kawasaki Kanagawa (JP)

(21) Appl. No.: 16/689,251

(22) Filed: Nov. 20, 2019

(30) Foreign Application Priority Data
Apr. 19, 2019 (JP) 2019-080333

(51) Int. Cl. G09F 3/20; G06F 3/0484; G06F 3/147; G06F 3/0488; H04W 4/80; G06Q 30/06; G09G 3/20; H01Q 1/22; G06Q 10/08

(52) U.S. Cl. CPC G09F 3/208; G06F 3/04845; G06F 3/147; G06F 3/0488; G09G 2370/16; G06Q 30/0643; G09G 3/2096; H01Q 1/2266; G06Q 10/087; H04W 4/80

(57) ABSTRACT

According to one embodiment, a merchandise shelf includes a display panel that displays an image showing a range in which a commodity is displayed, a touch panel for input of an operation correlated with the image, a memory that correlates and stores an ID of the commodity and the range in which the commodity is displayed, and a CPU that changes the range in which the commodity is displayed stored by the memory and changes the image showing the range in which the commodity is displayed by drag operation input to the touch panel.

### CROSS-REFERENCE TO RELATED APPLICATION

This application is based upon and claims the benefit of priority from Japanese Patent Application No. 2019-080333, filed in Apr. 19, 2019, the entire contents of which are incorporated herein by reference.

### FIELD

Embodiments described herein relate to a merchandise shelf.

### BACKGROUND

There is a technique as disclosed in JP-A-10-105832 of reading a commodity selection card assigned to each customer by an electronic shelf label located at the front edge of a display shelf on which commodities are placed and correlated with the commodities, and transmitting identification information of the commodities and identification information of the commodity selection card to a computer for transaction processing. Further, Albert Heijn B.V. in the Netherlands started service called Tap To Go. In Tap To Go, a user correlates and pre-registers means of settlement and a non-contact card with a user account using a smartphone application. When the user allows the electronic shelf label to read the pre-registered non-contact card, a settlement of the commodity correlated with the electronic shelf label is made.

There is a technique as disclosed in JP-A-7-17608 of centralized control by a computer to display shelf labels according to a changed self allocation in an electronic display unit of the shelf labels continuously provided in the front surface part of a shelf board.

### DESCRIPTION OF THE DRAWINGS

FIG. 1 is a conceptual diagram showing relationships among a group of units forming a checkout system according to one embodiment.

FIG. 2 shows respective parts of a shelf according to one embodiment.

FIG. 3 is an explanatory diagram (Part 1) of an example of a user experience when a customer purchases a commodity.

FIG. 4 is an explanatory diagram (Part 2) of the example of the user experience when the customer purchases the commodity.

FIG. 5 is an explanatory diagram (Part 3) of the example of the user experience when the customer purchases the commodity.

FIG. 6 is an explanatory diagram (Part 1) of an example of a user experience when a customer returns a commodity.

FIG. 7 is an explanatory diagram (Part 2) of the example of the user experience when the customer returns the commodity.

FIG. 8 is an explanatory diagram (Part 3) of the example of the user experience when the customer returns the commodity.

FIG. 9 is an explanatory diagram (Part 4) of the example of the user experience when the customer returns the commodity.

FIG. 10 is an explanatory diagram (Part 1) of an example of a user experience when a store clerk changes a shelf allocation.

FIG. 11 is an explanatory diagram (Part 2) of the example of the user experience when the store clerk changes the shelf allocation.

FIG. 12 is an explanatory diagram (Part 3) of the example of the user experience when the store clerk changes the shelf allocation.

FIG. 13 shows a configuration example (1) of an electronic shelf label.

FIG. 14 shows a configuration example (2) of the electronic shelf label.

FIG. 15 shows a configuration example (3) of the electronic shelf label.

FIG. 16 is a block diagram showing a configuration example of a shelf server.

FIG. 17 is a flowchart showing processing in the shelf server for an operation when a customer purchases a commodity.

FIG. 18 is a flowchart showing processing in the shelf server for an operation when a customer returns a commodity.

FIG. 19 is a flowchart showing processing in the shelf server for an operation when a store clerk changes a shelf allocation.

### DETAILED DESCRIPTION

A challenge is to reduce complication in settings of changes in shelf allocation in a computer.

In one embodiment, a merchandise shelf includes a display panel that displays an image showing a range in which a commodity is displayed, a touch panel for input of an operation correlated with the image, a memory that correlates and stores an ID of the commodity and the range in which the commodity is displayed, and a CPU that changes the range in which the commodity is displayed stored by the memory and changes the image showing the range in which the commodity is displayed by drag operation input to the touch panel.

As below, an embodiment of a checkout system will be explained using the drawings.

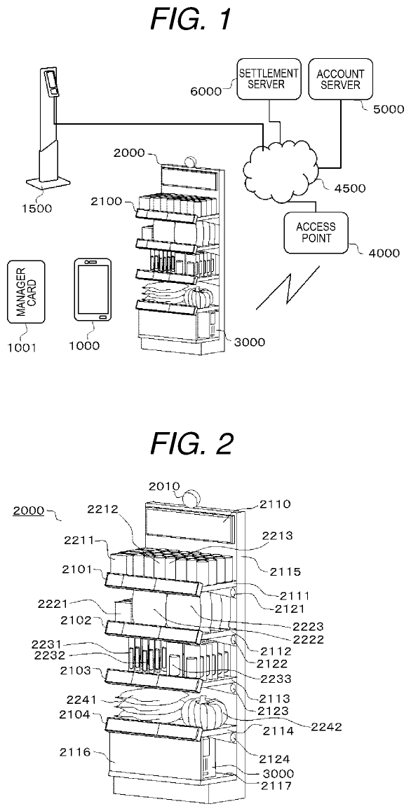

FIG. 1 is a conceptual diagram showing relationships among a group of units forming a checkout system according to one embodiment.

The checkout system has an NFC terminal 1000, a manager NFC terminal 1001, a check-in terminal 1500, a shelf 2000, a shelf server 3000, an access point 4000, an internet 4500, an account server 5000, and a settlement server 6000.

In the embodiment, the explanation will be made with the NFC terminal 1000 as the so-called NFC-capable smartphone capable of communicating information via the internet 4500 and executing and displaying a Web Browser as an application. The NFC terminal 1000 may be the so-called NFC IC card. In the embodiment, the explanation will be made with the manager NFC terminal 1001 as the so-called NFC IC card. The manager NFC terminal 1001 may be the so-called NFC-capable tablet PC. The NFC terminal 1000 and the manager NFC terminal 1001 have Unique IDs (IDs unique to terminals) for NFC.

The check-in terminal 1500, the access point 4000, the account server 5000, and the settlement server 6000 communicate information with one another via the internet 4500.

The check-in terminal 1500 is installed at the entrance of a store and provides the NFC Unique ID of the NFC terminal 1000 held over by a customer to use the checkout system to the account server 5000. Further, the check-in terminal 1500 provides the NFC Unique ID of the NFC terminal 1000 held over by a customer to exit to the account server 5000.

The check-in terminal 1500 captures a feature image of a face or figure of a customer holding over the NFC terminal 1000 with a camera, and, when the Unique ID of the NFC terminal 1000 and a customer ID derived from the feature image are not registered in the account server 5000, issues an alert indicating that someone else is trying to use the NFC terminal 1000.

The account server 5000 provides Web service for displaying that a purchased commodity was registered in a customer's account and a registered purchased commodity was deleted from a customer's account in the Web browser of the NFC terminal 1000.

The shelf server 3000 controls electronic operation of the shelf 2000 on which commodities are displayed. FIG. 2 shows respective parts of the shelf 2000.

The shelf 2000 includes an electronic shelf label 2101, an electronic shelf label 2102, an electronic shelf label 2103, an electronic shelf label 2104, a signage 2110, a shelf board 2111, a shelf board 2112, a shelf board 2113, a shelf board 2114, a back board 2115, a front board 2116, an undershelf chamber 2117, a speaker 2121, a speaker 2122, a speaker 2123, and a speaker 2124.

The back board 2115 respectively horizontally supports the shelf board 2111, the shelf board 2112, the shelf board 2113, and the shelf board 2114 from the top from back sides thereof.

The electronic shelf label 2101, the electronic shelf label 2102, the electronic shelf label 2103, and the electronic shelf label 2104 are provided at the respective front edges of the shelf board 2111, the shelf board 2112, the shelf board 2113, and the shelf board 2114.

The speaker 2121, the speaker 2122, the speaker 2123, and the speaker 2124 are provided at the respective side parts of the shelf board 2111, the shelf board 2112, the shelf board 2113, and the shelf board 2114.

The back board 2115 supports the signage 2110 above the top shelf board 2111.

The back board 2115 has the undershelf chamber 2117 under the bottom shelf board 2114. The front board 2116 hides the undershelf chamber 2117 from the space in front of the shelf 2000.

On the shelf boards 2111, 2112, 2113, and 2114, as commodities, cookies 2211, tube boxes of salty taste potato chips 2212, tube boxes of spicy taste potato chips 2213, biscuits 2221, tube bags of salty taste potato chips 2222, tube bags of spicy taste potato chips 2223, lipsticks 2231, eyeliners 2232, sunscreens 2233, rice bags 2241, and a pumpkin 2242 are arranged.

On the top shelf board 2111, from the electronic shelf label 2101 at the front end to the back board 2115 at the back end, one row of the cookies 2211, three rows of the tube boxes of salty taste potato chips 2212, and four rows of the tube boxes of spicy taste potato chips 2213 are arranged from the left.

On the second shelf board 2112 from the top, from the electronic shelf label 2102 at the front end to the back board 2115 at the back end, one row of the biscuits 2221, one row of the tube bags of salty taste potato chips 2222, and one row of the tube bags of spicy taste potato chips 2223 are arranged from the left.

On the third shelf board 2113 from the top, from the electronic shelf label 2103 at the front end to the back board 2115 at the back end, one row of the lipsticks 2231, one row of the eyeliners 2232, and two rows of the sunscreens 2233 are arranged from the left.

On the bottom shelf board 2114, from the electronic shelf label 2104 at the front end to the back board 2115 at the back end, one stack of the rice bags 2241 and the pumpkin 2242 are arranged from the left.

The shelf server 3000 is provided in the undershelf chamber 2117.

An example of a user experience of the shelf 2000 will be explained using the top shelf board 2111.

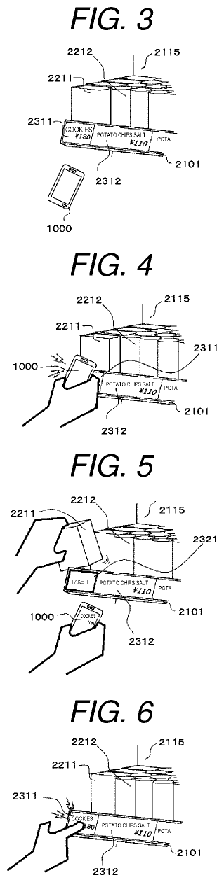

FIGS. 3, 4, and 5 are explanatory diagrams of an example of a user experience when a customer purchases a commodity.

In FIG. 3, the electronic shelf label 2101 displays a shelf location display standby image 2311 showing a name of a commodity “Cookies” and a width range where the commodity is placed and a shelf location display standby image 2312 showing a name of a commodity “Potato Chips Salt” and a width range where the commodity is placed.

The single row of the cookies 2211 is located on the shelf board 2111 on the back of the range in which the shelf location display standby image 2311 showing the name of the commodity “Cookies” and the width range where the commodity is placed in the electronic shelf label 2101 is displayed.

The three rows of the tube boxes of salty taste potato chips 2212 are located on the shelf board 2111 on the back of the range in which the shelf location display standby image 2312 showing the name of the commodity “Potato Chips Salt” and the width range where the commodity is placed in the electronic shelf label 2101 is displayed.

As shown in FIG. 4, when the customer holds the NFC terminal 1000 over the shelf location display standby image 2311 of “Cookies” of the shelf board 2111, the shelf 2000 beeps.

When the shelf 2000 beeps, “Cookies” is registered as a purchased commodity in the customer's account.

As shown in FIG. 5, after the shelf 2000 beeps, the NFC terminal 1000 displays that “Cookies” was registered as the purchased commodity in the customer's account in the Web browser thereof.

Further, the shelf location display standby image 2311 of “Cookies” of the electronic shelf label 2101 changes to a shelf location display purchase image 2321 containing a character string “Take It” or the like different from the shelf location display standby image 2311. Then, the customer takes the cookies 2211 from the shelf board 2111.

FIGS. 6, 7, 8, and 9 are explanatory diagrams of an example of a user experience when a customer returns a commodity.

As shown in FIG. 6, when the customer touches the shelf location display standby image 2311 of “Cookies” of the shelf board 2111, the shelf 2000 beeps.

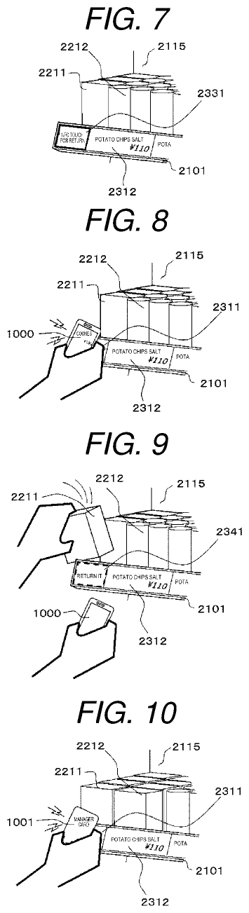

As shown in FIG. 7, after the shelf 2000 beeps, the shelf location display standby image 2311 of “Cookies” of the electronic shelf label 2101 changes to a shelf location display return standby image 2331 containing a character string “NFC Touch for Return” or the like different from the shelf location display standby image 2311.

As shown in FIG. 8, when the customer holds the NFC terminal 1000 over the shelf location display standby image 2311 of “Cookies” of the electronic shelf label 2101, the shelf 2000 beeps, and then, as shown in FIG. 9, the shelf location display return standby image 2331 of the electronic shelf label 2101 changes to a shelf location display return instruction image 2341 containing a character string “Return It” or the like different from the shelf location display standby image 2311 or the shelf location display return standby image 2331.

When the customer holds the NFC terminal 1000 over the shelf location display return instruction image 2341 of the electronic shelf label 2101 and the shelf 2000 beeps, the previously registered “Cookies” is deleted from the purchased commodities in the customer's account. The NFC terminal 1000 displays that the previously registered “Cookies” was deleted from the purchased commodities in the customer's account in the Web browser thereof.

Then, the customer places the cookies 2211 to return on the shelf board 2111 at the back in the range in which the shelf location display return instruction image 2341 is displayed.

The shelf location display standby image 2311, the shelf location display purchase image 2321, the shelf location display return standby image 2331, and the shelf location display return instruction image 2341 may be respectively different in pattern, but may show the same width range as images showing the ranges in which the commodities are displayed.

FIGS. 10, 11, and 12 are explanatory diagrams of an example of a user experience when a store clerk changes a shelf allocation.

The commodity arrangement on the shelf board 2111 in which the row of the tube boxes of salty taste potato chips 2212 is placed on the right of the single row of the cookies 2211 at the left end in FIG. 3 is changed to an arrangement in which the cookies 2211 are increased into two rows from the left end and the row of the tube boxes of salty taste potato chips 2212 is placed on the right.

The electronic shelf label 2101 displays the shelf location display standby image 2311 showing the name of the commodity “Cookies” and the width range where the commodity is placed and the shelf location display standby image 2312 showing the name of a commodity “Potato Chips Salt” and the width range where the commodity is placed sequentially from the left, however, the single row of the cookies 2211 is arranged at the back of the range in which the shelf location display standby image 2312 showing the name of the commodity “Potato Chips Salt” and the width range where the commodity is placed is displayed and there is a mismatch between the shelf location display standby image 2312 and the commodities arranged at the back.

It is desired to extend the shelf location display standby image 2311 of “Cookies” by the single row of the cookies 2211 to the right and shorten the shelf location display standby image 2312 of “Potato Chips Salt” by the single row of the cookies 2211.

When the store clerk holds the manager NFC terminal 1001 over the electronic shelf label 2101, the shelf 2000 beeps.

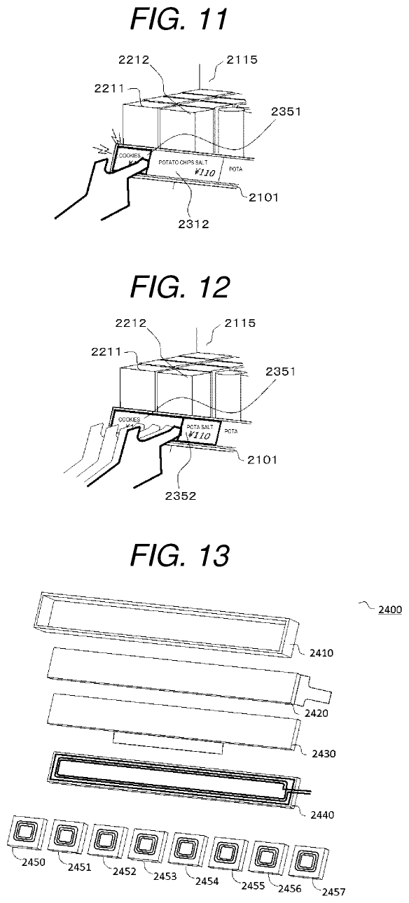

As shown in FIG. 11, the shelf 2000 beeps, and then, the shelf location display standby image 2311 of “Cookies” of the electronic shelf label 2101 changes to a shelf location change standby image 2351 to be surrounded by a thick frame or the like different from the shelf location display standby image 2311.

When the store clerk touches a position at a boundary between the shelf location display standby image 2311 of “Cookies” and the shelf location display standby image 2312 of “Potato Chips Salt”, as shown in FIG. 12, the shelf location display standby image 2312 of “Potato Chips Salt” changes to a shelf location change standby image 2352 to be surrounded by a thick frame or the like different from the shelf location display standby image 2312.

When the clerk drags the boundary by the single row of the cookies 2211 to the right, the shelf location display standby image 2311 of “Cookies” of the electronic shelf label 2101 extends by the single row of the cookies 2211 to the right, and the shelf location display standby image 2312 of “Potato Chips Salt” becomes shorter by the single row of the cookies 2211.

Configuration examples of the electronic shelf label that may be used as the electronic shelf label 2101 for realization of the user experiences explained using FIGS. 3 to 12 will be explained using FIGS. 13 to 15.

An electronic shelf label 2400 of the configuration example in FIG. 13 communicates with an NFC terminal and outputs contents of the communication and a location on the electronic shelf label 2400 in the leftward and rightward directions over which the NFC terminal is held as signals.

The electronic shelf label 2400 includes a frame 2410. The frame 2410 is made of e.g. stainless or resin. The frame 2410 supports a touch panel 2420, a display panel 2430, an NFC antenna panel 2440, and speaker panels 2450 to 2547 sequentially from the front surface.

For the touch panel 2420, the display panel 2430, and the NFC antenna panel 2440, configurations based on NFC displays disclosed in e.g. WO2016/185768 and WO2016/185769 may be used. The display panel 2430 as a display unit is not limited to those, but e.g. liquid crystal, organic EL, the so-called electronic paper may be used.

The speaker panels 2450 to 2547 are used for beeping the shelf, for example. The configuration example includes a plurality of beeping elements in the leftward and rightward width directions of the electronic shelf label 2400 to beep in a location closest to the location over which the NFC terminal is held on the electronic shelf label 2400. The speaker panels 2450 to 2547 are supported by the frame 2410 to face to beep toward the back surface of the electronic shelf label 2400 without being hindered by the touch panel 2420, the display panel 2430, or the NFC antenna panel 2440.

The electronic shelf label 2400 having the above described configuration is connected to the shelf server 3000 via an electronic shelf label driver. The electronic shelf label driver changes the contents of the communication with the NFC terminal output by the NFC antenna panel 2440 into a format that may be received by the shelf server 3000 and transmits the contents to the shelf server 3000. Further, the electronic shelf label driver changes a signal indicating a location over which the NFC terminal is held sensed by the touch panel 2420 into a format that may be received by the shelf server 3000 and transmits the signal to the shelf server 3000. Furthermore, the electronic shelf label driver changes the image of the display panel 2430 based on an image signal output by the shelf server 3000. Moreover, the electronic shelf label driver beeps the speaker panels 2450 to 2547 based on a sound signal output by the shelf server 3000.

Note that the only one beeping element may be provided if a beeping location may be anywhere on the electronic shelf label 2400. If the beeping location may be anywhere on the shelf board 2111, the speaker 2121 may be used and the speaker panel 2450 is not necessarily provided in the electronic shelf label 2400.

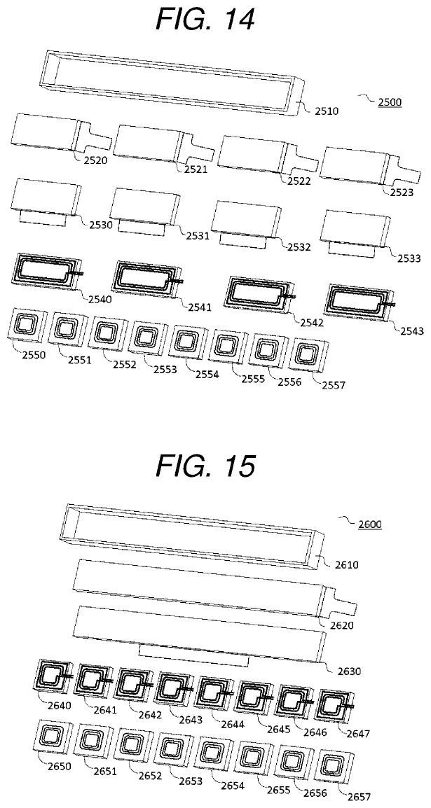

It is not necessary that the single touch panel, display panel, and NFC antenna panel are provided for each electronic shelf label, but a plurality of touch panels 2520, 2521, 2522, and 2523, a plurality of display panels 2530, 2531, 2532, and 2533, and a plurality of NFC antenna panels 2540, 2541, 2542, and 2543 may be provided like an electronic shelf label 2500 of the configuration example in FIG. 14.

The electronic shelf label 2500 having the above described configuration is connected to the shelf server 3000 via an electronic shelf label driver.

The electronic shelf label driver changes the contents of the communication with the NFC terminal output by the NFC antenna panels 2540, 2541, 2542, and 2543 into a format that may be received by the shelf server 3000 and transmits the contents to the shelf server 3000. Further, the electronic shelf label driver changes a signal indicating a location over which the NFC terminal is held sensed by the touch panels 2520, 2521, 2522, and 2523 divided in the leftward and rightward directions of the electronic shelf label 2500 into a format that may be received by the shelf server 3000 as a location over which the NFC terminal is held entirely in the leftward and rightward directions of the electronic shelf label 2500 and transmits the signal to the shelf server 3000. Furthermore, the electronic shelf label driver changes the images of the display panels 2530, 2531, 2532, and 2533 based on an image signal entirely in the leftward and rightward directions of the electronic shelf label 2500 output by the shelf server 3000. Moreover, the electronic shelf label driver beeps the speaker panels 2450 to 2547 based on a sound signal output by the shelf server 3000.

If it is impossible for the touch panel to detect the location over which the NFC terminal is held, for example, as shown in FIG. 15, a plurality of NFC antenna panels 2640 to 2647 having narrower widths may be arranged in the leftward and rightward directions of an electronic shelf label 2600 and which NFC antenna panel can communicate may be used for detection of the location over which the NFC terminal is held.

The electronic shelf label 2600 having the above described configuration is connected to the shelf server 3000 via an electronic shelf label driver.

The electronic shelf label driver changes the contents of the communication with the NFC terminal output by the NFC antenna panels 2640 to 2647 into a format that may be received by the shelf server 3000 and transmits the contents to the shelf server 3000. Further, the electronic shelf label driver changes which of the NFC antenna panels 2640 to 2647 communicates as information indicating the location over which the NFC terminal is held into a format that may be received by the shelf server 3000 and transmits the information to the shelf server 3000. Furthermore, the electronic shelf label driver changes the image of a display panel 2630 based on an image signal output by the shelf server 3000. Moreover, the electronic shelf label driver beeps the speaker panels 2450 to 2547 based on a sound signal output by the shelf server 3000.

The configuration examples are shown in FIGS. 13 to 15 and the explanation thereof, however, the electronic shelf label is not limited to those.

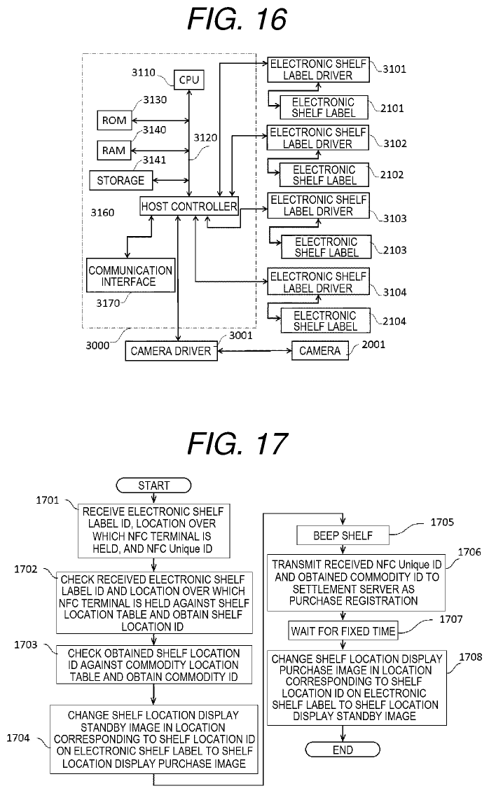

A configuration example of the shelf server 3000 that may be used in combination with the electronic shelf label will be explained using the block diagram in FIG. 16.

The shelf server 3000 includes a CPU (Central Processing Unit) 3110.

The CPU 3110 communicates with a ROM 3130, a RAM 3140, a storage 3141, and a host controller 3160 via a bus line 3120.

The ROM 3130 stores programs to be executed by the CPU 3110 and data necessary for the CPU 3110 to execute the programs.

The CPU 3110 receives an image signal from a camera 2001 via the host controller 3160 or a camera driver 3001. The CPU 3110 captures a feature image of a face or figure of a customer using the camera 2001. Further, the CPU 3110 images commodities on the shelf using the camera 2001. The CPU 3110 warns of omission of payment when a missing commodity on the shelf is recognized from the captured image, but the customer did not perform any operation to purchase the commodity within an imaging range of the camera 2001.

The CPU 3110 displays images on the electronic shelf labels 2101, 2102, 2103, and 2104 via the host controller 3160 and electronic shelf label drivers 3101, 3102, 3103, and 3104.

The RAM 3140 stores temporary data etc. when the CPU 3110 executes the programs. The CPU 3110 may once load and divide the images to be displayed on the signage 2110 and the electronic shelf labels 2101, 2102, 2103, and 2104 in the RAM 3140 and displays the images on the respective electronic shelf labels 2101, 2102, 2103, and 2104 so that the images on the signage 2110 and the electronic shelf labels 2101, 2102, 2103, and 2104 appear to move in conjunction with one another. The movements include e.g. flowing movements upward and downward and leftward and rightward in the signage 2110 and the electronic shelf labels 2101, 2102, 2103, and 2104 and movements of blinking and character movements. Direct advertisements according to the feature of the customer in front of the shelf 2000 imaged by the camera 2001 may be displayed on the signage 2110 and the electronic shelf labels 2101, 2102, 2103, and 2104.

The CPU 3110 receives contents of the communication with the NFC terminal and the location over which the NFC terminal is held in the leftward and rightward directions of the electronic shelf label as signals from the electronic shelf labels 2101, 2102, 2103, and 2104 via the host controller 3160 and the electronic shelf label drivers 3101, 3102, 3103, and 3104.

The CPU 3110 controls a communication interface 3170 via the host controller 3160 to configure WLAN by wireless communication with the access point 4000.

TABLE 1

| Electronic | Location in Shelf Allocation Area | | Shelf |
|---|---|---|---|
| shelf label ID | Left End (%) | Right End (%) | Location ID |
| 2101 | 0 | 15 | 1A |
| 2101 | 16 | 55 | 1B |
| 2101 | 56 | 100 | 1C |
| 2102 | 0 | 15 | 2A |
| 2102 | 16 | 60 | 2B |
| 2102 | 61 | 100 | 2C |
| 2103 | 0 | 28 | 3A |
| 2103 | 29 | 57 | 3B |
| 2103 | 58 | 100 | 3C |
| 2104 | 0 | 57 | 4A |
| 2104 | 58 | 100 | 4B |

Table 1 is an example of a shelf location table stored by the storage 3141 of the shelf server 3000 for use of the electronic shelf label 2400 in the configuration example in FIG. 13 and the electronic shelf label 2500 in the configuration example in FIG. 14.

The storage 3141 stores shelf location IDs with electronic shelf label IDs and locations in a shelf allocation area as keys.

The electronic shelf label IDs are IDs correlated with the respective electronic shelf labels 2101, 2102, 2103, and 2104.

The location in the shelf allocation area is information for specifying the location in the leftward and rightward directions on the electronic shelf label. In the example of Table 1, percentages of the locations ranging from the left end of the electronic shelf labels are specified.

In the example of Table 1, the shelf location ID 1A is correlated with the range from 0% to 15% from the left end of the electronic shelf label 2101, the shelf location ID 1B is correlated with the range from 16% to 55% from the left end, and the shelf location ID 1C is correlated with the range from 56% to 100% from the left end. Further, the shelf location ID 2A is correlated with the range from 0% to 15% from the left end of the electronic shelf label 2102, the shelf location ID 2B is correlated with the range from 16% to 60% from the left end, and the shelf location ID 2C is correlated with the range from 61% to 100% from the left end. Furthermore, the shelf location ID 3A is correlated with the range from 0% to 28% from the left end of the electronic shelf label 2103, the shelf location ID 3B is correlated with the range from 29% to 57% from the left end, and the shelf location ID 3C is correlated with the range from 58% to 100% from the left end. Moreover, the shelf location ID 4A is correlated with the range from 0% to 57% from the left end of the electronic shelf label 2104 and the shelf location ID 4B is correlated with the range from 58% to 100% from the left end.

TABLE 2

| Shelf | |
|---|---|
| Location ID | Commodity ID |
| 1A | Cookies |
| 1B | Tube box of salty taste potato chips |
| 1C | Tube box of spicy taste potato chips |
| 2A | Biscuits |
| 2B | Tube bag of salty taste potato chips |
| 2C | Tube bag of spicy taste potato chips |
| 3A | Lipstick |
| 3B | Eyeliner |
| 3C | Sunscreen |
| 4A | Rice bag |
| 4B | Pumpkin |

Table 2 is an example of a commodity location table stored by the storage 3141 of the shelf server 3000.

The storage 3141 stores the commodity IDs with the shelf location IDs as keys.

The commodity IDs are IDs correlated with the respective cookies 2211, tube box of salty taste potato chips 2212, tube box of spicy taste potato chips 2213, biscuits 2221, tube bag of salty taste potato chips 2222, tube bag of spicy taste potato chips 2223, lipstick 2231, eyeliner 2232, sunscreen 2233, rice bag 2241, and pumpkin 2242.

In the example of Table 2, the cookies 2211 is correlated with the shelf location ID 1A, the tube box of salty taste potato chips is correlated with the shelf location ID 1B, and the tube box of spicy taste potato chips is correlated with the shelf location ID 1C. Further, the biscuits is correlated with the shelf location ID 2A, the tube bag of salty taste potato chips is correlated with the shelf location ID 2B, and the tube bag of spicy taste potato chips is correlated with the shelf location ID 2C. Furthermore, the lipstick is correlated with the shelf location ID 3A, the eyeliner is correlated with the shelf location ID 3B, and the sunscreen is correlated with the shelf location ID 3C. Moreover, the rice bag is correlated with the shelf location ID 4A, and the pumpkin 2242 is correlated with the shelf location ID 4B.

TABLE 3

| Commodity ID | Price (Yen) |
|---|---|
| Cookies | 180 |
| Tube box of salty taste potato chips | 110 |
| Tube box of spicy taste potato chips | 130 |
| Biscuits | 260 |
| Tube bag of salty taste potato chips | 220 |
| Tube bag of spicy taste potato chips | 260 |
| Lipstick | 700 |
| Eyeliner | 900 |
| Sunscreen | 600 |
| Rice bag | 1,180 |
| Pumpkin | 400 |

Table 3 is an example of a commodity price table stored by the settlement server 6000.

The settlement server 6000 stores prices with the commodity IDs as keys.

In the example of Table 3, the price 180 yen is correlated with the commodity ID cookies, the price 110 yen is correlated with the commodity ID tube box of salty taste potato chips, and the price 130 yen is correlated with the commodity ID tube box of spicy taste potato chips. Further, the price 260 yen is correlated with the commodity ID biscuits, the price 220 yen is correlated with the commodity ID tube bag of salty taste potato chips, and the price 260 yen is correlated with the commodity ID tube bag of spicy taste potato chips. Furthermore, the price 700 yen is correlated with the commodity ID lipstick, the price 900 yen is correlated with the commodity ID eyeliner, and the price 600 yen is correlated with the commodity ID sunscreen. Moreover, the price 1180 yen is correlated with the commodity ID rice bag, and the price 400 yen is correlated with the commodity ID pumpkin.

TABLE 4
NFC-UID
F9FF7FFF6FFFF0FF
6E21E0EEE9EE7EEE

Table 4 is an example of a manager information table stored by the shelf server 3000.

The storage 3141 stores Unique IDs of the NFC terminal 1000 and the manager NFC terminal 1001.

In the example of Table 4, there are the Unique ID “F9FF7FFF6FFFF0FF” of the NFC terminal 1000 and the Unique ID “6E21E0EEE9EE7EEE” of the manager NFC terminal 1001.

TABLE 5

| NFC-UID | Customer ID | Check-in Status |
|---|---|---|
| 012D9E91440F5DBA | Taro Yamada | Checked in |
| 333B765432196222 | Taro Yamada | Out |
| BAE91F5D014402D9 | Ichiro Tanaka | Out |
| 9E91F5D440BA012D | Saburo Suzuki | Out |

Table 5 is an example of a user terminal table stored by the account server 5000.

The account server 5000 stores the customer IDs with the NFC Unique IDs as keys.

In the example of Table 5, the customer ID “Taro Yamada” is correlated with the Unique ID “012D9E91440F5DBA”, the customer ID “Taro Yamada” is correlated with the Unique ID “333B765432196222”, the customer ID “Ichiro Tanaka” is correlated with the Unique ID “BAE91F5D014402D9”, and the customer ID “Saburo Suzuki” is correlated with the Unique ID “9E91F5D440BA012D”.

TABLE 6

| | Incomings | | | |
|---|---|---|---|---|
| Customer | and | | | Price |
| ID | Outgoings | NFC-UID | Commodity ID | (Yen) |
| Taro | Purchased | 012D9E91440F5DBA | Cookies | 180 |
| Yamada | | | | |
| Taro | Purchased | 012D9E91440F5DBA | Biscuits | 260 |
| Yamada | | | | |
| Taro | Purchased | 333B765432196222 | Pumpkin | 400 |
| Yamada | | | | |
| Ichiro | Purchased | BAE91F5D014402D9 | Tube bag of salty | 220 |
| Tanaka | | | taste potato chips | |
| Ichiro | Purchased | BAE91F5D014402D9 | Tube bag of salty | 220 |
| Tanaka | | | taste potato chips | |
| Ichiro | Purchased | BAE91F5D014402D9 | Tube bag of salty | 220 |
| Tanaka | | | taste potato chips | |
| Ichiro | Purchased | BAE91F5D014402D9 | Tube bag of spicy | 260 |
| Tanaka | | | taste potato chips | |
| Saburo | Purchased | 9E91F5D440BA012D | Lipstick | 700 |
| Suzuki | | | | |
| Saburo | Purchased | 9E91F5D440BA012D | Eyeliner | 900 |
| Suzuki | | | | |
| Saburo | Purchased | 9E91F5D440BA012D | Biscuits | 260 |
| Suzuki | | | | |
| Saburo | Returned | 9E91F5D440BA012D | Biscuits | 260 |
| Suzuki | | | | |
| Saburo | Purchased | 9E91F5D440BA012D | Sunscreen | 600 |
| Suzuki | | | | |
| Saburo | Purchased | 9E91F5D440BA012D | Tube box of salty | 110 |
| Suzuki | | | taste potato chips | |

Table 6 is an example of a user purchased commodity registration table stored by the account server 5000.

The account server 5000 stores the NFC Unique IDs, the commodity IDs, and the commodity prices with the customer IDs as keys together with incomings and outgoings flags indicating purchase registrations or return registrations.

In the example of Table 6, the incomings and outgoings flag “Purchased”, the Unique ID “012D9E91440F5DBA”, the commodity ID cookies, and the price 180 yen are correlated with the customer ID “Taro Yamada”, the incomings and outgoings flag “Purchased”, the Unique ID “012D9E91440F5DBA”, the commodity ID biscuits, and the price 260 yen are correlated with the customer ID “Taro Yamada”, the incomings and outgoings flag “Purchased”, the Unique ID “333B765432196222”, the commodity ID pumpkin, and the price 400 yen are correlated with the customer ID “Taro Yamada”. Further, the incomings and outgoings flag “Purchased”, the Unique ID “BAE91F5D014402D9”, the commodity ID tube bag of salty taste potato chips, and the price 220 yen are correlated with the customer ID “Ichiro Tanaka”, the incomings and outgoings flag “Purchased”, the Unique ID “BAE91F5D014402D9”, the commodity ID tube bag of salty taste potato chips, and the price 220 yen are correlated with the customer ID “Ichiro Tanaka”, the incomings and outgoings flag “Purchased”, the Unique ID “BAE91F5D014402D9”, the commodity ID tube bag of salty taste potato chips, and the price 220 yen are correlated with the customer ID “Ichiro Tanaka”, and the incomings and outgoings flag “Purchased”, the Unique ID “BAE91F5D014402D9”, the commodity ID tube bag of spicy taste potato chips, and the price 260 yen are correlated with the customer ID “Ichiro Tanaka”. Further, the incomings and outgoings flag “Purchased”, the Unique ID “9E91F5D440BA012D”, the commodity ID lipstick, and the price 700 yen are correlated with the customer ID “Saburo Suzuki”, the incomings and outgoings flag “Purchased”, the Unique ID “9E91F5D440BA012D”, and the commodity ID Eyeliner, and the price 900 yen are correlated with the customer ID “Saburo Suzuki”, the incomings and outgoings flag “Purchased”, the Unique ID “9E91F5D440BA012D”, the commodity ID biscuits, and the price 260 yen are correlated with the customer ID “Saburo Suzuki”, the incomings and outgoings flag “Returned”, the Unique ID “9E91F5D440BA012D”, the commodity ID biscuits, and the price 260 yen are correlated with the customer ID “Saburo Suzuki”, the incomings and outgoings flag “Purchased”, the Unique ID “9E91F5D440BA012D”, the commodity ID sunscreen, and the price 600 yen are correlated with the customer ID “Saburo Suzuki”, and the incomings and outgoings flag “Purchased”, the Unique ID “9E91F5D440BA012D”, the commodity ID tube box of salty taste potato chips, and the price 110 yen are correlated with the customer ID “Saburo Suzuki”.

TABLE 7

| Customer ID | Balance (Yen) |
|---|---|
| Taro Yamada | 10,000 |
| Ichiro Tanaka | 76,590 |
| Saburo Suzuki | 9,189 |

Table 7 is an example of a user balance table stored by the account server 5000.

The account server 5000 stores the balances of the accounts of the customers with the customer IDs as keys.

In the example of Table 7, the balance 10000 yen of the account of the customer is correlated with the customer ID “Taro Yamada”, the balance 76590 yen of the account of the customer is correlated with the customer ID “Ichiro Tanaka”, and the balance 9189 yen of the account of the customer is correlated with the customer ID “Saburo Suzuki”.

TABLE 8

| Electronic | | Shelf |
|---|---|---|
| shelf label ID | Antenna ID | Location ID |
| 2101 | 2640 | 1A |
| 2101 | 2641 | 1A |
| 2101 | 2642 | 1B |
| 2101 | 2643 | 1B |
| 2101 | 2644 | 1B |
| 2101 | 2645 | 1C |
| 2101 | 2646 | 1C |
| 2101 | 2647 | 1C |
| 2102 | 2640 | 2A |
| 2102 | 2641 | 2A |
| 2102 | 2642 | 2B |
| 2102 | 2643 | 2B |
| 2102 | 2644 | 2B |
| 2102 | 2645 | 2C |
| 2102 | 2646 | 2C |
| 2102 | 2647 | 2C |
| 2103 | 2640 | 3A |
| 2103 | 2641 | 3A |
| 2103 | 2642 | 3B |
| 2103 | 2643 | 3B |
| 2103 | 2644 | 3C |
| 2103 | 2645 | 3C |
| 2103 | 2646 | 3C |
| 2103 | 2647 | 3C |
| 2104 | 2640 | 4A |
| 2104 | 2641 | 4A |
| 2104 | 2642 | 4A |
| 2104 | 2643 | 4A |
| 2104 | 2644 | 4A |
| 2104 | 2645 | 4B |
| 2104 | 2646 | 4B |
| 2104 | 2647 | 4B |

Table 8 is an example of a shelf location table stored by the storage 3141 of the shelf server 3000 for use of the electronic shelf label 2600 of the configuration example in FIG. 15.

The storage 3141 stores the shelf location IDs with the electronic shelf label IDs and the antenna IDs as keys.

To show which of the antenna panels 2640 to 2647 arranged in the leftward and rightward directions of the electronic shelf label 2600 could communicate the location over which the NFC terminal is held in the leftward and rightward directions of the electronic shelf label 2600, the antenna IDs are correlated with the respective plurality of NFC antenna panels 2640 to 2647.

In the example of Table 8, what number antenna from the left end of the electronic shelf label corresponds to which shelf location is specified.

In the example of Table 8, the shelf location ID 1A is correlated with the antenna IDs 2640 and 2641 of the electronic shelf label 2101, the shelf location ID 1B is correlated with the antenna IDs 2642, 2643, and 2644, and the shelf location ID 1C is correlated with the antenna IDs 2645, 2646 and 2647. Further, the shelf location ID 2A is correlated with the antenna IDs 2640 and 2641 of the electronic shelf label 2102, the shelf location ID 2B is correlated with the antenna IDs 2642, 2643, and 2644, and the shelf location ID 2C is correlated with the antenna IDs 2645, 2646, and 2647. Furthermore, the shelf location ID 3A is correlated with the antenna IDs 2640 and 2641 of the electronic shelf label 2103, the shelf location ID 3B is correlated with the antenna IDs 2642 and 2643, and the shelf location ID 3C is correlated with the antenna IDs 2644, 2645, 2646, and 2647. Moreover, the shelf location ID 4A is correlated with the antenna IDs 2640, 2641, 2642, 2643, and 2644 of the electronic shelf label 2104, and the shelf location ID 4B is correlated with the antenna IDs 2645, 2646, and 2647.

Operations of the shelf server 3000 will be described.

The processing by the CPU 3110 of the shelf server 3000 with respect to the operations when the customer purchases the commodity shown in FIGS. 3, 4, and 5 will be explained. Note that the configuration example shown in FIG. 13 or 14 is used as the electronic shelf label 2101.

FIG. 17 is a flowchart showing the processing by the CPU 3110 of the shelf server 3000.

The CPU 3110 receives the electronic shelf label ID, the location over which the NFC terminal 1000 is held, and the NFC Unique ID via the host controller 3160 and the electronic shelf label driver 3101 from the electronic shelf label 2101 (1701). Note that, if the configuration in FIG. 15 is used as the electronic shelf label 2101, the CPU 3110 receives the antenna ID in place of the location over which the NFC terminal 1000 is held of the electronic shelf label 2101.

The CPU 3110 checks the received electronic shelf label ID and location over which the NFC terminal 1000 is held against the shelf location table loaded from the storage 3141 onto the RAM 3140, and obtains the shelf location ID (1702). Note that, if the configuration in FIG. 15 is used as the electronic shelf label 2101, the CPU 3110 checks the antenna ID in place of the location over which the NFC terminal 1000 is held against the shelf location table.

The CPU 3110 checks the obtained shelf location ID against the commodity location table loaded from the storage 3141 onto the RAM 3140, and obtains the commodity ID (1703).

The CPU 3110 loads the shelf location display purchase image 2321 corresponding to the commodity ID obtained at 1703 from the storage 3141 onto the RAM 3140, and allows the electronic shelf label driver 3101 via the host controller 3160 to display the shelf location display purchase image 2321 corresponding to the commodity ID obtained at 1703 in the location of the shelf location display standby image 2311 corresponding to the shelf location ID obtained at 1702 instead (1704).

The CPU 3110 beeps the electronic shelf label 2101 via the host controller 3160 and the electronic shelf label driver 3101 (1705). Note that, if the beeping location may be anywhere, the speaker 2121 may beep in place of the electronic shelf label 2101.

The CPU 3110 transmits the received NFC Unique ID and the obtained commodity ID as a purchase registration to the settlement server 6000 via the host controller 3160 and the communication interface 3170 (1706).

The settlement server 6000 checks the commodity ID of the purchase registration received from the shelf server 3000 against the commodity price table and obtains the price. The settlement server 6000 transmits the Unique ID and the commodity ID of the purchase registration received from the shelf server 3000 and the obtained price to the account server 5000.

The account server 5000 checks the Unique ID of the purchase registration received from the settlement server 6000 against the user terminal table and obtains the customer ID.

Further, the account server 5000 adds the received Unique ID, commodity ID, and price and the obtained customer ID to the user purchase commodity registration table with the incomings and outgoings flag of the purchase registration.

Furthermore, the account server 5000 subtracts the received price of the purchase registration from the balance on the user balance table of the obtained customer ID.

The CPU 3110 waits for a fixed time (1707), and then, loads the shelf location display standby image 2311 corresponding to the commodity ID obtained at 1703 from the storage 3141 onto the RAM 3140 and allows the electronic shelf label driver 3101 via the host controller 3160 to display the shelf location display standby image 2311 corresponding to the commodity ID obtained at 1703 in the location of the shelf location display purchase image 2321 corresponding to the shelf location ID obtained at 1702 instead (1708).

Then, the CPU 3110 ends the processing.

The processing by the CPU 3110 of the shelf server 3000 with respect to the operations when the customer returns the commodity as shown in FIGS. 6, 7, 8, and 9 will be explained. Note that the configuration example shown in FIG. 13 or 14 is used as the electronic shelf label 2101.

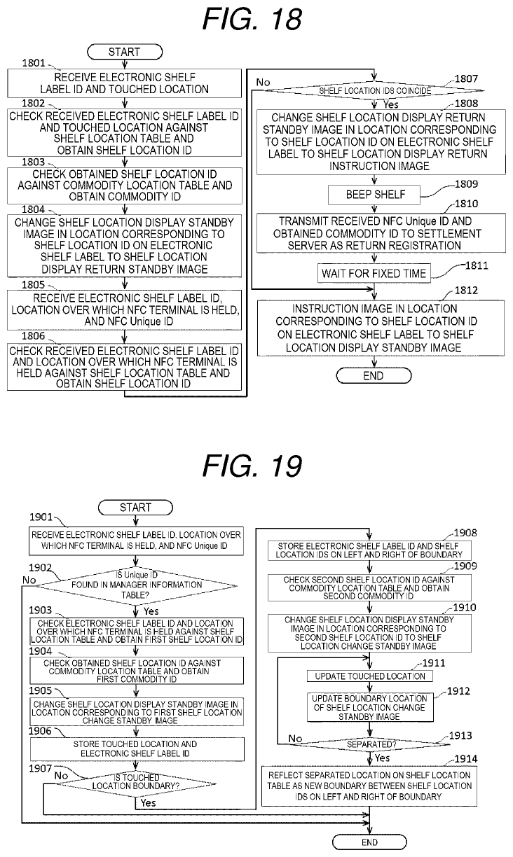

FIG. 18 is a flowchart showing the processing by the CPU 3110 of the shelf server 3000.

The CPU 3110 receives the electronic shelf label ID and the touched location of the electronic shelf label 2101 from the electronic shelf label 2101 via the host controller 3160 and the electronic shelf label driver 3101 (1801).

The CPU 3110 checks the received electronic shelf label ID and touched location of the electronic shelf label 2101 against the shelf location table loaded from the storage 3141 onto the RAM 3140, and obtains the shelf location ID (1802).

The CPU 3110 checks the obtained shelf location ID against the commodity location table loaded from the storage 3141 onto the RAM 3140, and obtains the commodity ID (1803).

The CPU 3110 loads the shelf location display standby image 2311 corresponding to the commodity ID obtained at 1803 from the storage 3141 onto the RAM 3140 and allows the electronic shelf label driver 3101 via the host controller 3160 to display the shelf location display return standby image 2331 corresponding to the commodity ID obtained at 1803 in the location of the shelf location display standby image 2311 corresponding to the shelf location ID obtained at 1802 instead (1804).

The CPU 3110 receives the electronic shelf label ID, the location over which the NFC terminal 1000 is held, and the NFC Unique ID via the host controller 3160 and the electronic shelf label driver 3101 from the electronic shelf label 2101 (1805). Note that, if the configuration in FIG. 15 is used as the electronic shelf label 2101, the CPU 3110 receives the antenna ID in place of the location over which the NFC terminal 1000 is held of the electronic shelf label 2101.

The CPU 3110 checks the received electronic shelf label ID and location over which the NFC terminal 1000 is held against the shelf location table loaded from the storage 3141 onto the RAM 3140, and obtains the shelf location ID (1806). Note that, if the configuration in FIG. 15 is used as the electronic shelf label 2101, the CPU 3110 checks the antenna ID in place of the location over which the NFC terminal 1000 is held against the shelf location table.

If the shelf location ID obtained at 1802 and the shelf location ID obtained at 1806 coincide (Yes at 1807), the CPU 3110 loads the shelf location display return instruction image 2341 corresponding to the commodity ID obtained at 1803 from the storage 3141 onto the RAM 3140, and allows the electronic shelf label driver 3101 via the host controller 3160 to display the shelf location display return instruction image 2341 corresponding to the commodity ID obtained at 1803 in the location of the shelf location display return standby image 2331 corresponding to the shelf location ID obtained at 1802 instead (1808).

The CPU 3110 beeps the electronic shelf label 2101 via the host controller 3160 and the electronic shelf label driver 3101 (1809). Note that, if the beeping location may be anywhere, the speaker 2121 may beep in place of the electronic shelf label 2101.

The CPU 3110 transmits the received NFC Unique ID and the obtained commodity ID as a return registration to the settlement server 6000 via the host controller 3160 and a communication interface 3180 (1810).

The settlement server 6000 checks the commodity ID of the return registration received from the shelf server 3000 against the commodity price table and obtains the price. The settlement server 6000 transmits the Unique ID and the commodity ID of the return registration received from the shelf server 3000 and the obtained price to the account server 5000.

The account server 5000 checks the Unique ID of the return registration received from the settlement server 6000 against the user terminal table and obtains the customer ID.

Further, the account server 5000 adds the received Unique ID, commodity ID, and price and the obtained customer ID to the user purchase commodity registration table with the incomings and outgoings flag in the return registration.

Furthermore, the account server 5000 adds the received price of the return registration to the balance on the user balance table of the obtained customer ID.

The CPU 3110 waits for a fixed time (1811), and then, loads the shelf location display standby image 2311 corresponding to the commodity ID obtained at 1803 from the storage 3141 onto the RAM 3140 and allows the electronic shelf label driver 3101 via the host controller 3160 to display the shelf location display standby image 2311 corresponding to the commodity ID obtained at 1803 in the location of the shelf location display return instruction image 2341 corresponding to the shelf location ID obtained at 1802 instead (1812).

If the shelf location ID obtained at 1802 and the shelf location ID obtained at 1806 do not coincide at 1807 (No at 1807), the CPU do not execute 1808 to 1811, but executes 1812.

Then, the CPU 3110 ends the processing.

The processing by the CPU 3110 of the shelf server 3000 with respect to the operations when the store clerk changes the shelf allocation as shown in FIGS. 10, 11, and 12 will be explained. Note that the configuration example shown in FIG. 13 or 14 is used as the electronic shelf label 2101.

FIG. 19 is a flowchart showing the processing by the CPU 3110 of the shelf server 3000.

The CPU 3110 receives the electronic shelf label ID, the location over which the NFC terminal 1000 is held, and the NFC Unique ID from the electronic shelf label 2101 via the host controller 3160 and the electronic shelf label driver 3101 (1901). Note that, if the configuration in FIG. 15 is used as the electronic shelf label 2101, the CPU 3110 receives the antenna ID in place of the location over which the NFC terminal 1000 is held of the electronic shelf label 2101.

The CPU 3110 checks the received Unique ID against the manager information table loaded from the storage 3141 onto the RAM 3140 (1902).

If the received Unique ID is not found in the manager information table (No at 1902), the CPU ends processing.

If the received Unique ID is found in the manager information table (Yes at 1902), the CPU 3110 checks the received electronic shelf label ID and location over which the NFC terminal 1000 is held against the shelf location table loaded from the storage 3141 onto the RAM 3140, and obtains the first shelf location ID (1903). Note that, if the configuration in FIG. 15 is used as the electronic shelf label 2101, the CPU 3110 checks the antenna ID in place of the location over which the NFC terminal 1000 is held against the shelf location table.

The CPU 3110 checks the obtained first shelf location ID against the commodity location table loaded from the storage 3141 onto the RAM 3140, and obtains the first commodity ID (1904).

The CPU 3110 loads the shelf location change standby image 2351 corresponding to the first commodity ID obtained at 1904 from the storage 3141 onto the RAM 3140, and allows the electronic shelf label driver 3101 via the host controller 3160 to display the shelf location change standby image 2351 corresponding to the first commodity ID in the location of the shelf location display standby image 2311 corresponding to the first shelf location ID instead (1905).

The CPU 3110 receives the electronic shelf label ID and the touched location of the electronic shelf label 2101 from the electronic shelf label 2101 via the host controller 3160 and the electronic shelf label driver 3101 and holds the received ID and location in the RAM 3140 (1906).

The CPU 3110 checks the received electronic shelf label ID and touched location of the electronic shelf label 2101 against the shelf location table loaded from the storage 3141 onto the RAM 3140 (1907).

The CPU 3110 ends the processing if the received electronic shelf label ID and touched location of the electronic shelf label 2101 are not at the boundary between the shelf allocation areas on the shelf location table (No at 1907).

If the received electronic shelf label ID and touched location of the electronic shelf label 2101 are at the boundary between the shelf allocation areas on the shelf location table (Yes at 1907), the CPU 3110 holds the received electronic shelf label ID, the first shelf location ID, the second shelf location ID as a shelf location ID of the shelf location adjacent with the boundary determined at 1907 in between to the shelf location of the shelf location ID obtained at 1903 on the shelf location table in the RAM 3140 (1908).

The CPU 3110 checks the second shelf location ID against the commodity location table loaded from the storage 3141 onto the RAM 3140, and obtains the second commodity ID (1909).

Further, the CPU 3110 loads the shelf location change standby image 2352 corresponding to the second commodity ID from the storage 3141 onto the RAM 3140, and allows the electronic shelf label driver 3101 via the host controller 3160 to change to the shelf location change standby image 2352 corresponding to the second commodity ID in the location of the shelf location display standby image 2312 corresponding to the second shelf location ID instead (1910).

Note that a range may be provided for determination as to whether or not the touched location is at the boundary between the shelf allocation areas on the shelf location table. For example, the determination that the touched location is at the boundary between the shelf allocation areas on the shelf location table may be made even if the location is out of the boundary by around 1%.

The CPU 3110 updates the touched location of the electronic shelf label 2101 held in the RAM 3140 at 1906 to the touched location received from the electronic shelf label 2101 via the host controller 3160 and the electronic shelf label driver 3101 (1911).

The CPU 3110 sets the right end of the shelf location change standby image 2351 in the location corresponding to the first shelf location ID as the shelf location ID on the left of the boundary loaded on the RAM 3140 to the latest updated touched location at 1911. Further, the CPU 3110 sets the left end of the shelf location change standby image 2352 in the location corresponding to the second shelf location ID as the shelf location ID on the right of the boundary loaded on the RAM 3140 to the latest updated touched location at 1911 (1912).

While the electronic shelf label 2101 is transmitting the touched location (No at 1913), the acts at 1911 and 1912 are repeated.

If the electronic shelf label 2101 no longer transmits the touched location (Yes at 1913), the CPU 3110 sets the latest touched location held in the RAM 3140 to the right end of the shelf allocation area of the record on the shelf location table loaded on the RAM 3140 corresponding to the first shelf location ID. Further, the CPU sets the latest touched location held in the RAM 3140 to the left end of the shelf allocation area of the record on the shelf location table loaded on the RAM 3140 corresponding to the second shelf location ID (1914).

Note that it is preferable to design the processing by the CPU 3110 to appropriately set the boundary so that the adjacent shelf allocation areas may not overlap.

The CPU 3110 updates the shelf location table on the storage 3141 with the contents of the shelf location table loaded on the storage 3141 and ends the processing.

The structures of the images including the shelf location display standby image 2311, the shelf location display purchase image 2321, the shelf location display return standby image 2331, the shelf location display return instruction image 2341, and the shelf location change standby image 2351 stored in the storage 3141 are not limited to the structures in the so-called raster forms. However, the structures in the vector forms or structures in which outline fonts and objects in other forms are combined and, even when the widths of the images change according to expansion and contraction of the shelf allocation areas, the images change to images without feelings of strangeness may be used. For instance, in the examples from FIGS. 10 to 12, “Potato Chips Salt” is displayed in the shelf location change standby image 2352 in the location corresponding to the second shelf location ID, however, an abbreviated character string “Pota Salt” is displayed in the shelf location change standby image 2352 narrowed after the boundary change, and a feeling of strangeness that the entire character string “Potato Chips Salt” is uniformly reduced, blurred, and unclear is avoided.

FIG. 19 shows the example for realization of the so-called drag operation by the acts at 1911, 1912, and 1913, however, the acts may be replaced by many existing methods replaceable as the processing for realization of the drag operation. Or, pseudo-inertial movement of the boundary by the so-called swipe operation may be employed.

The CPU 3110 changes the shelf allocation area and changes the image showing the shelf location displayed by the display panel according to the drag operation, and thus, complication in changes in shelf allocation on the merchandise shelf including the electronic shelf labels correlated with the commodities may be reduced. The reduction of the complication leads to suppression of power consumption for the changes in shelf allocation on the merchandise shelf including the electronic shelf labels.

As described above, the programs for realization of the functions of the exemplary embodiments are recorded in the ROM as a program storage unit within the apparatus in advance, however, the same programs may be downloaded from the network to the apparatus. Or, the same programs recorded in a recording medium may be installed in the apparatus. The recording medium may have any form that can store programs and is readable by the apparatus such as a CD-ROM or memory card. Further, the functions obtained by installation or download of the programs may be realized in cooperation with an OS (operating system) within the apparatus or the like.

While certain embodiments have been described, these embodiments are presented as examples, but not intended to limit the scope of the invention. These novel embodiments may be implemented in other various forms and various omissions, replacements, changes may be made without departing from the scope of the invention. These embodiments or their modifications are within the scope of the invention and within the scope of the invention described in claims and equivalents thereof.

What is claimed is:

1. A merchandise shelf, comprising:
a display that displays an image showing a range in which a commodity is displayed;
a touch panel for input of an operation correlated with the image;
a memory that correlates and stores an identifier of the commodity and the range; and
a processor that changes the range stored by the memory and changes the image showing the range displayed by the display panel by a drag operation input to the touch panel.

2. The merchandise shelf according to claim 1, wherein the display and the touch panel are superimposed.

3. The merchandise shelf according to claim 1, further comprising:
an antenna for wireless communication with a terminal and reading of a terminal identifier; and
a communication interface that transmits the terminal identifier and the identifier of the commodity after reading of the terminal identifier via the antenna.

4. The merchandise shelf according to claim 3, wherein the display and the antenna are superimposed.

5. The merchandise shelf according to claim 1, wherein the processor changes the range stored by the memory to an end point of the drag operation, and changes an end of the image showing the range displayed by the display to an end point of the drag operation.

6. The merchandise shelf according to claim 1, wherein the display and the touch panel are share a screen.

7. The merchandise shelf according to claim 1, wherein the processor is a central processing unit.

8. The merchandise shelf according to claim 1, further comprising:
a speaker that makes a noise when the commodity is selected for purchase.

9. The merchandise shelf according to claim 1, wherein the display and the processor are connected by wireless communication.

10. The merchandise shelf according to claim 1, further comprising:
a settlement server that correlates the commodity with a price.

11. A merchandise shelf method, comprising:
displaying an image showing a range in which a commodity is displayed;
performing an operation correlated with the image;
correlating and storing an identifier of the commodity and the range in a memory; and
changing, by a processor, the range stored by the memory and changing the image showing the range displayed by a drag operation input.

12. The merchandise shelf method according to claim 11, further comprising:
wirelessly communicating with a terminal and reading a terminal identifier; and
transmitting the terminal identifier and the identifier of the commodity after reading the terminal identifier.

13. The merchandise shelf method according to claim 11, wherein changing the range stored by the memory to an end point of the drag operation, and changing an end of the image showing the range displayed to an end point of the drag operation.

14. The merchandise shelf method according to claim 11, further comprising:
making a noise when the commodity is selected for purchase.

15. The merchandise shelf method according to claim 11, wherein a display and the processor are connected by wireless communication.

16. The merchandise shelf method according to claim 11, further comprising:
correlating the commodity with a price.

17. A merchandise processing system, comprising:
a display that displays an image showing a range in which a commodity is displayed;
a touch panel for input of an operation correlated with the image;
a memory that correlates and stores an identifier of the commodity and the range;
a processor that changes the range stored by the memory and changes the image showing the range displayed by the display panel by a drag operation input to the touch panel; and
a settlement server that correlates the commodity with a price.

18. The merchandise processing system according to claim 17, wherein the display and the touch panel are superimposed.

19. The merchandise processing system according to claim 17, further comprising:
an antenna for wireless communication with a terminal and reading of a terminal identifier; and
a communication interface that transmits the terminal identifier and the identifier of the commodity after reading of the terminal identifier via the antenna.

20. The merchandise processing system according to claim 17, wherein the processor changes the range stored by the memory to an end point of the drag operation, and changes an end of the image showing the range displayed by the display to an end point of the drag operation.
